(19) United States
(12) Patent Application Publication
(10) Pub. No.: US 2023/0087536 A1
(43) Pub. Date: Mar. 23, 2023

(54) BOTTLE TYPE COOLING PACK

(71) Applicant: FMS-KOREA CO., LTD., Hwaseong-si, Gyeonggi-do (KR)

(72) Inventor: Dong Ho CHOI, Seoul (KR)

(73) Assignee: FMS-KOREA CO., LTD., Hwaseong-si, Gyeonggi-do (KR)

(21) Appl. No.: 17/800,539

(22) PCT Filed: Jun. 8, 2020
(86) PCT No.: PCT/KR2020/007404

§ 371 Date: Aug. 18, 2022

(30) Foreign Application Priority Data
Feb. 20, 2020 (KR) 20-2020-0000585

(51) Int. Cl. F25D 3/08; F28D 20/02

(52) U.S. Cl. CPC F25D 3/08; F28D 20/02; F25D 2303/082

(57) ABSTRACT

The present invention provides a bottle type cooling pack including a case, which: has a storage space formed therein to store a refrigerant including a phase change material (PCM), the phase of which varies according to temperature; has a front surface and a rear surface, the widths of which are wider than that of a side surface thereof; and has a rectangular hexahedral shape formed through the front surface and rear surface and curved in the forward and backward directions.

### TECHNICAL FIELD

The present invention relates to a bottle type cooling pack, and more particularly, to a bottle type cooling pack, wherein, when a plurality of cooling packs are stacked and frozen, the curved shape of a case of each of the plurality of cooling packs enables the side surfaces of cooling packs disposed in the middle or lower portion of the stack of the packs to be also exposed to the outside so that the freezing speed can be increased.

### BACKGROUND ART

In general, ice packs are used instead of ice when various fresh foods such as agricultural products, livestock products, and marine products are stored at low temperatures and are transported so that these fresh foods do not deteriorate. However, because these fresh foods lose their function as food when they are left at an appropriate temperature or higher even for a short period of time, an appropriate temperature needs to be continuously maintained. Thus, the supply of ice packs at an appropriate temperature is important for maintaining the freshness of fresh foods.

However, ice packs need to be frozen so as to maintain an appropriate temperature, and a refrigerator for this is required. Ice packs according to the related art are mainly used in the form of plates, and when these ice packs are frozen in large quantities, they are stacked and frozen in order to freeze a larger number of ice packs. In this case, ice packs arranged in the middle of the stacked ice packs have a relatively small area exposed to the outside, so that the freezing speed is decreased.

### DETAILED DESCRIPTION OF THE INVENTION

### Technical Problem

The present invention provides a bottle type cooling pack, wherein, when a plurality of cooling packs are stacked and frozen, the curved shape of a case of each of the plurality of cooling packs enables the side surfaces of cooling packs disposed in the middle or lower portion of the stack of the packs to be also exposed to the outside so that the freezing speed can be increased.

### Technical Solution

According to an aspect of the present invention, there is provided a bottle type cooling pack including a case, which has a storage space formed therein to store a refrigerant including a phase change material (PCM), the phase of which varies according to temperature, has a front surface and a rear surface, widths of which are wider than that of a side surface thereof, and has a rectangular hexahedral shape formed through the front surface and rear surface and curved in forward and backward directions, wherein, in the case, the front surface and the rear surface are curved in the forward and backward directions, and the width of the front surface is greater than the width of the rear surface, and on the front surface, a plurality of grooves having a linear structure with respect to the widthwise direction so that absorption of cold energy from an outside or emission of cold energy inside the case can be quickly performed, are formed to be spaced apart from one another in a lengthwise direction of the case, and on the rear surface, a plurality of grooves having a linear structure with respect to the widthwise direction so that absorption of cold energy from an outside or emission of cold energy inside the case can be quickly performed, is are formed to be spaced apart from one another in a lengthwise direction of the case, and when multiple cases are stacked in the forward and backward directions and change into a sold phase, a width of the front surface of the case disposed in a lower portion of a stack of the packs is more smaller than a width of the rear surface of the case disposed in an upper portion of the stack of the packs so that the case disposed in the lower portion is exposed by a difference between the width of the front surface of the case disposed in the lower portion and the width of the rear surface of the case disposed in the upper portion.

### Effects of the Invention

According to the present invention, a bottle type cooling pack has the following effects.

First, when a plurality of cooling packs are stacked and frozen, the curved shape of a case of each of the plurality of cooling packs enables the edge portions of cooling packs disposed in the middle or lower portion of the stack of the packs to be also exposed to the outside so that the freezing speed can be increased.

Second, because cold air can be transmitted between grooves of a linear structure formed on the outer circumferential surface of the case and the cold energy of a refrigerant can be emitted, time can be saved when freezing or supplying the cold air to an object required to be maintained at low temperature.

Third, when multiple cases are stacked, protrusions of the case disposed in the lower portion of the stack of the cases and insertion grooves of the case stacked on the upper portion of the stack of the cases are combined with one another, so that the case stacked on the upper portion of the stack of the cases is fixed without slipping.

### DESCRIPTION OF THE DRAWINGS

FIG. 1 is one side perspective view of a bottle type cooling pack according to an embodiment of the present invention.

FIG. 2 is the other side perspective view of the bottle type cooling pack shown in FIG. 1.

FIG. 3 is a top plan view of the bottle type cooling pack of FIG. 1.

FIG. 4 is a schematic view from the other side of the bottle type cooling pack of FIG. 1.

FIG. 5 is a schematic view illustrating a case where, when three bottle type cooling packs of FIG. 1 are stacked and frozen, cold air passes between the cooling packs and comes into contact with the cooling packs.

### MODE OF THE INVENTION

Hereinafter, the present invention will be described in detail by describing a preferred embodiment of the present invention with reference to the accompanying drawings.

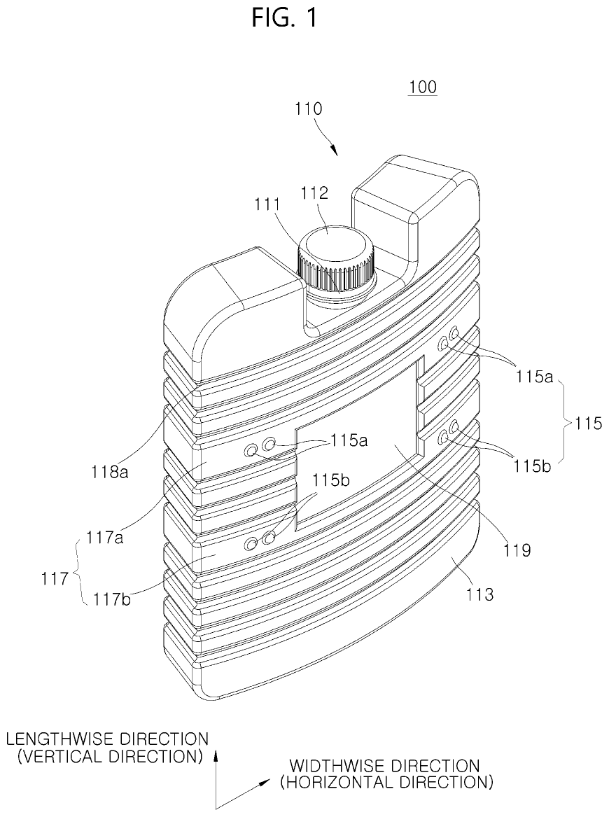

Referring to FIGS. 1 through 4, a bottle type cooling pack 100 according to an embodiment of the present invention includes a case 110 and a refrigerant (not shown). The case 110 has a space formed therein to store the refrigerant, has a side surface of which width is narrow, has a front surface 113 and a rear surface 114, the widths of which are wider than that of the side surface thereof, and has a rectangular hexahedral shape formed through the front surface 113 and rear surface 114 and curved in forward and backward directions. The case 110 is formed of material such as polyethylene terephthalate. Of course, the material for the case 110 may be varied. In the case 110, eight corner portions corresponding to vertices having the rectangular hexahedral shape are formed in a round structure rather than a right angle structure so that a user who handles the case 110 can be prevented from being injured by sharp corners. Also, even when the case 110 falls to the ground or is in contact with other objects to receive impact, the risk of breakage can be reduced.

Because the case 110 has rigidity to maintain the shape, like in a general plastic container, unlike an existing pouch type cooling pack, the bottle type cooling pack 100 does not require an additional material for shape maintenance, like in an existing cooling pack. Also, the case 110 may discharge the refrigerant (not shown) after use and may be separately collected and thus is ecofriendly, and the refrigerant is frozen again or is re-injected and frozen and thus may be re-used and the case 110 is suitable for resource recycling (resource circulation).

The case 110 has an injection portion 111, which is formed in an upper portion of the case 110 and through which the refrigerant (not shown) may be injected and discharged. The case 110 has a “U”-shaped groove formed in an upper end in which the injection portion 111 is formed. The injection portion 111 is formed in the U-shaped groove. Thus, the case 110 has no entirely protruding portions in spite of the presence of the injection portion 111 and thus is maintained in the rectangular hexahedral structure. Also, because the injection portion 111 is formed in the U-shaped groove, the risk of breakage caused by contact with the outside can be remarkably reduced.

Also, the case 110 includes an injection portion stopper 112 for opening/closing the injection portion 111. The injection portion 111 has a similar structure to that of a cylindrical beverage outlet formed in a general drink bottle, and has a screw thread formed on an outer circumferential surface of the injection portion 111. The injection portion stopper 112 has a similar structure to that of a general drink lid, and has a screw thread that may be screw connected to the injection portion 111 and is formed on an inner circumferential surface of the injection portion 111. In the present embodiment, the combined structure of the injection portion 111 and the injection portion stopper 112 has been described as a screw connection structure, but any combined structure of the injection portion stopper 112 in which the refrigerant may be injected and discharged, may be modified.

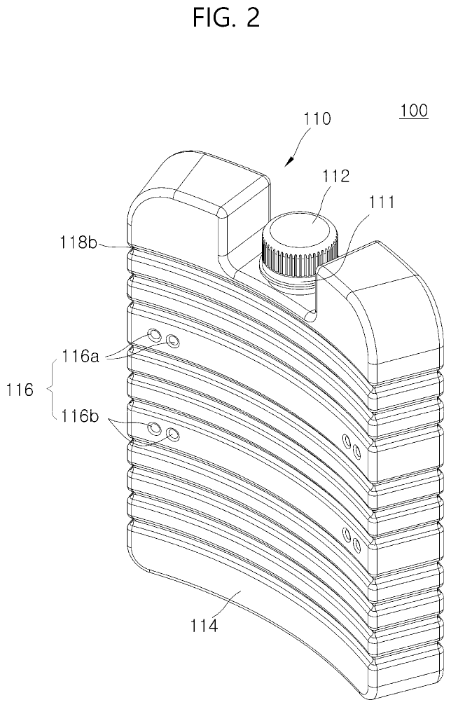

In the case 110, a wide and curved surface shown in FIG. 1 is referred to as a front surface 113. A surface which faces the front surface 113 and of which width is narrower than that of the front surface, is referred to as a rear surface 114. The rear surface 114 is a surface having a wide and curved shape shown in FIG. 2. That is, the bottle type cooling pack 100 has a shape which is long in lengthwise and widthwise directions and of which the thickness corresponding to the width of the side surface is small, as shown in FIG. 1.

Because the case 110 has a structure which is curved in one direction rather than a plate shape, the case 110 may be flexibly in contact with the rear surface 114 of the case 110 when coming into contact with fresh foods generally packaged in a plastic bag or the like. Also, because the front surface 113 has a greater width than that of the rear surface 114 and surrounds the front surface 113, there is an effect in which cold energy in the bottle type cooling pack 100 is well collected in a direction of the rear surface 114 and is emitted. Thus, an object required to be maintained at low temperature and disposed in the rear surface 114 may receive cold air effectively.

Protrusions 115 are formed on the front surface 113 of the case 110, as shown in FIG. 1. The protrusions 115 include first protrusions 115a formed in pairs on the left and right sides, respectively, two of the first protrusions 115a being adjacent to each other in an upper portion of the first protrusions 115a to form a pair, and second protrusions 115b formed in a lower portion of the first protrusions 115 to be spaced apart from the first protrusions 115 and formed in pairs on the left and right sides, respectively. That is, the protrusions 115 are formed in four areas spaced apart from one another by a set distance in the lengthwise and widthwise directions based on the center of the front surface 113 of the case 110. In the present embodiment, the protrusions 115 include the first protrusions 115a and the second protrusions 115b, which are formed on the left and right sides of the front surface 113, respectively. However, the protrusions 115 may include only one of the first protrusions 115a and the second protrusions 115b. Also, only one of the first protrusions 115a and the second protrusions 115b may be formed without forming a pair. Also, the protrusions 115 may not be formed on the left and right sides of the front surface 113, respectively, but only one of the first protrusions 115a and the second protrusions 115b may be respectively formed while the first protrusions 115a and the second protrusions 115b are spaced apart from each other in the lengthwise direction in the center. A label groove 119 may be formed in the center of the front surface 113 of the case 110 so that a label may be attached/detached to/from the case 110. The label groove 119 has a label attachment/detachment function and a groove shape, thereby increasing the surface area of the case 110.

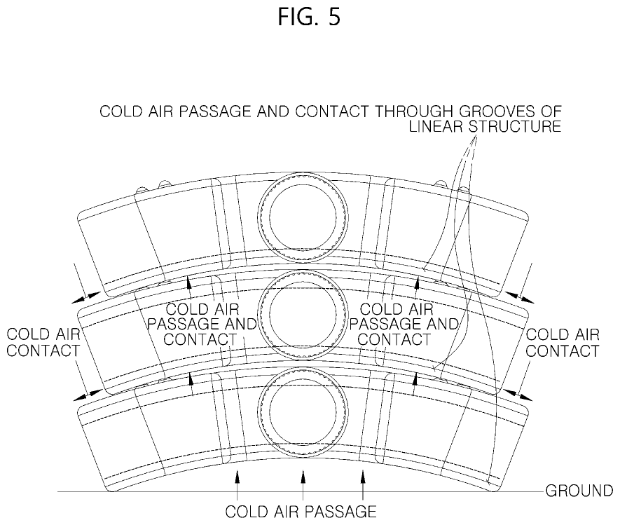

Insertion grooves 116 are formed in the rear surface 114 of the case 110, as shown in FIG. 2. The insertion grooves 116 are formed to be combined with the protrusions 115 formed on the front surface 113. That is, the insertion grooves 116 are formed so that the protrusions 115 of the case 110 disposed in the lower portion of the case 110 and the insertion grooves 116 of the case 110 disposed in the upper portion of the case 110 when two or more cases 110 are stacked, as shown in FIG. 5, can be press-fitted to each other. The insertion grooves 116 include first insertion grooves 116a formed in pairs on the left and right sides, respectively, two of the first insertion grooves 116a being adjacent to each other in an upper portion of the first insertion grooves 116a to form a pair, and second insertion grooves 116b formed in a lower portion of the first insertion grooves 116a to be spaced apart from the first insertion grooves 116a and formed in pairs on the left and right sides, respectively. That is, the insertion grooves 116 are formed in four areas spaced apart from one another by a set distance in the lengthwise and widthwise directions based on the center of the rear surface 114 of the case 110. In the present embodiment, the insertion grooves 116 include the first insertion grooves 116a and the second insertion grooves 116b, which are formed on the left and right sides of the rear surface 114, respectively. However, the insertion grooves 116 may include only one of the first insertion grooves 116a and the second insertion grooves 116b. Also, only one of the first protrusions 115a and the second protrusions 115b may be formed without forming a pair. Also, the protrusions 115 may not be formed on the left and right sides of the front surface 113, respectively, but only one of the first protrusions 115a and the second protrusions 115b may be respectively formed while the first protrusions 115a and the second protrusions 115b are spaced apart from each other in the lengthwise direction in the center.

When two or more cases 110 are stacked, as shown in FIG. 5, the protrusions 115 and the insertion grooves 116 are combined with each other and fixed through press fit. In this case, in the present embodiment, the protrusions 115 are completely press-fitted to the insertion grooves 116, however, the protrusions 115 may be inserted into the middle portion of the insertion grooves 116 or up to ⅔ of the depth of the insertion grooves 116. That is, the depth at which the protrusions 115 are inserted into the insertion grooves 116, may be adjusted stepwise. This is because, when a plurality of cases 110 are stacked and frozen, if there is a lot of free space in a freezer, the protrusions 115 are inserted into the insertion grooves 116 only by half so that cold air passes well between the cases 110 disposed in the lower portion and the case 110 stacked on the upper portion, is in contact therewith and if the free space of the freezer is small, the protrusions 115 are completely inserted into the insertion rooves 116 so that the stacking height can be reduced.

The refrigerator (not shown) stored in the case 110 uses mainly water. However, when the water changes from a liquid state to a solid state, that is, when the water changes to ice, unlike other general cases, the volume of the water increases. Accordingly, the case 110 may be subjected to a force by the ice that expands when the water freezes, and may be deformed. However, due to this deformation, as shown in FIG. 5, when the plurality of cases 110 are stacked and frozen, press-fit between the protrusions 115 of the case 110 disposed in the lower portion and the insertion grooves 116 of the case 110 stacked on the upper portion may not be well performed. Thus, in the present invention, in order to reduce the deformation, a rib structure 117 is formed on the front surface 113 and the rear surface 114. In the present embodiment, the rib structure 117 is different from a general rib. When the rib structure 117 is compared with a portion between grooves 118 of a linear structure formed in a band shape in a widthwise direction, in a concave-convex structure formed on an outer circumferential surface of the case 110 by the grooves 118 of the linear structure to be described later, the width in the lengthwise direction is greater than the width in the widthwise direction. That is, the rib structure 117 has the greater width in the lengthwise direction than the width of the band in the widthwise direction so that the rib structure 117 can further withstand with respect to contraction or expansion of the case 110. In particular, the rib structure 117 is formed in the widthwise direction, thereby controlling contraction or expansion of the protrusions 115 and the insertion grooves 116 in the widthwise direction.

The rib structure 117 includes a first rib structure 117 formed in a portion in which the first protrusions 115a and the first insertion grooves 116a are formed, and a second rib structure 117b formed in a portion in which the second protrusions 115b and the second insertion grooves 116b are formed. That is, the first rib structure 117a is formed in the widthwise direction along an outer circumferential surface of the case 110, the first protrusions 115a are formed on the front surface 113 in which the first rib structure 117a is formed, and the first insertion grooves 116a are formed in the rear surface 114. The second rib structure 117b is spaced apart from the first rib structure 117a in the lengthwise direction of the first rib structure 117a, wherein the second protrusions 115b are formed on the front surface 113 in which the second rib structure 117b is formed, and the second insertion grooves 116b are formed on the rear surface 114. In the bottle type cooling pack 100, deformation occurs only in the lengthwise direction by the rib structure 117 formed in the widthwise direction when water that is the refrigerant (not shown) is frozen and expands. Thus, the widthwise distance between the protrusions 115 and the widthwise distance between the insertion grooves 116 hardly change. Thus, because even when the bottle type cooling pack 100 is deformed, the rib structure 117 limits widthwise deformation, a problem that the protrusions 115 and the insertion grooves 116 are not combined with each other and collapse in a state where the bottle type cooling packs 100 are stacked, can be solved. In the present embodiment, the protrusions 115 and the insertion grooves 116 may be respectively formed in one of portions between portions in which the grooves 118 of the linear structure are formed.

The grooves 118 of the linear structure are formed on the outer circumferential surface of the case 110. The grooves 118 of the linear structure include grooves 118a of a first linear structure formed on the front surface 113 and grooves 118b of a second linear structure formed on the rear surface 114. A plurality of grooves 118 of the linear structure are formed in the widthwise direction to be spaced apart from one another in parallel to the rib structure 117 in the lengthwise direction. Thus, the outer circumferential surface of the case 110 forms a concave-convex structure while portions where the grooves 118 of the linear structure are formed and portions where no grooves 118 of the linear structure are formed, are repeated. When the case 110 is frozen by increasing the surface area of the case 110, more cold air is in contact with the grooves 118 of the linear structure so that the refrigerant (not shown) stored in the case 110 can be rapidly cooled. Of course, due to the increased surface area by the grooves 118 of the linear structure, in the bottle type cooling pack 100, even when cold energy is emitted onto an object required to be maintained at low temperature, cold energy can be emitted more rapidly than the case where the grooves 118 of the linear structure are not present.

In the present embodiment, the grooves 118 of the linear structure are formed in one linear structure in which the grooves 118 are connected without broken portions. However, the present invention is not limited thereto, and the grooves 118 of the linear structure may also be formed only on the front surface 113 and the rear surface 114. Because when a plurality of cases 110 are stacked, they are stacked to face each other between the grooves 118 of the linear structure, even when the cases 110 are stacked and frozen, cold air may flow between the grooves 118 of the linear structure so that, even when the plurality of cases 110 are stacked and frozen, the degree of reducing the cooling speed is small.

The refrigerant (not shown) uses phase change materials (PCM) of which phases change according to temperature. In the present embodiment, an example of the refrigerant is water of which phase changes between the solid state and the liquid state. Of course, the type of the refrigerant may change. The refrigerant (not shown) may be injected through the injection portion 111 of the case 110, and when the refrigerant (not shown) needs to be replaced, in a state in which the refrigerant (not shown) is in a liquid phase state, the injection portion stopper 112 is opened, and the refrigerant is discharged through the injection portion 111.

In the present embodiment, water used as the refrigerant uses general water that is not purified. However, the present invention is not limited thereto, and water used as the refrigerant is purified and thus, water that may be directly drunk may also be used. This means that, after the bottle type cooling pack 100 is used for the purpose of maintaining temperature of fresh food or the like, the bottle type cooling pack 100 can be used for the purpose such as mineral water. Thus, the utilization of the refrigerant that has been used for the purpose of use, rather than simply discharging the refrigerant that has reached the existing purpose of use so that resources can be saved and efficiency can be promoted. Of course, the purified water can be frozen and re-used as a refrigerant.

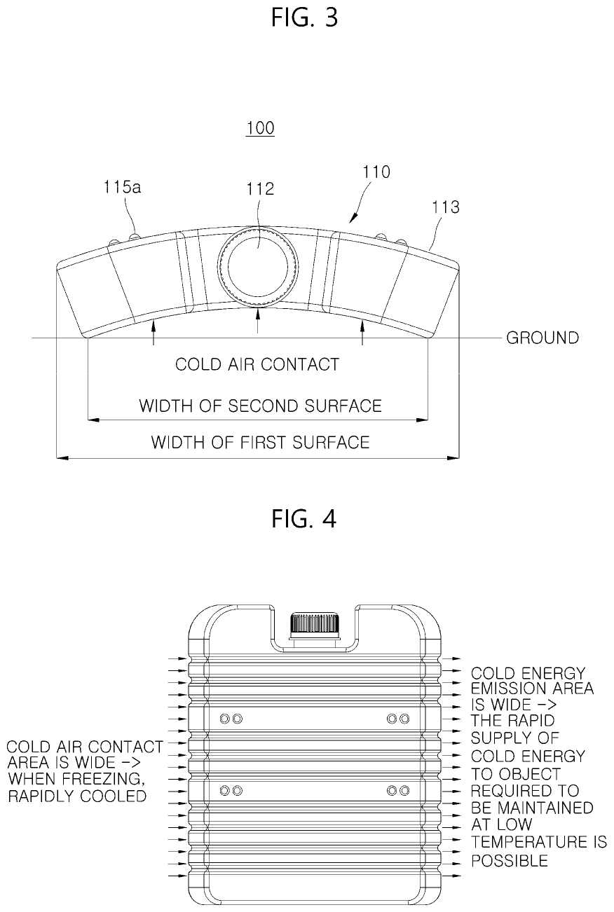

Referring to FIG. 5, FIG. 5 illustrates that the case 110 shown in FIG. 1 is cooled in a state in which three cases 110 are stacked. For convenience of explanation, the case 110 disposed in a lowermost side is referred to as a first case, the case 110 disposed in the middle is referred to as a second case, and the case 110 stacked in an uppermost portion is referred to as a third case. In the case 110, as shown in FIG. 3, the width of the front surface 113 is greater than the width of the rear surface 114. Thus, because, when the front surface 113 of the first case and the rear surface 114 of the second case are stacked while facing each other, the width of the front surface 113 of the first case is greater than the width of the rear surface 114 of the second case, left and right edges of the first case disposed at a lower side is not covered by the first case and is exposed to the outside. Thus, cold air may be in contact with the left and right edges of the first case. In this structure, the left and right edge portions of the second case are not covered by the third case but are exposed to the outside and thus may be in direct contact with cold air.

When the cases 110 are formed in a plate structure and stacked, when widths of facing surfaces are the same, a surface on which cold air may contact the cases 110, is reduced, when a plurality of cases 110 are stacked and frozen, the cooling speed is decreased. Fresh foods cannot be used any more when they are deteriorated in a state in which they are at higher temperature than required temperature. Thus, it is significant to rapidly supply the cooling pack. Thus, structurally, the present invention having a structure in which the cooling pack can be cooled in large quantities at a short time can satisfy demand characteristics of a product.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

By using the present invention, a bottle type cooling pack, wherein, when a plurality of cooling packs are stacked and frozen, edge portions of cooling packs disposed in the middle or lower portion of the stack of the packs to be also exposed to the outside so that the freezing speed can be increased, can be provided.

1. A bottle type cooling pack comprising a case, which has a storage space formed therein to store a refrigerant including a phase change material (PCM), the phase of which varies according to temperature, has a front surface and a rear surface, widths of which are wider than that of a side surface thereof, and has a rectangular hexahedral shape formed through the front surface and rear surface and curved in forward and backward directions,
wherein, in the case, the front surface and the rear surface are curved in the forward and backward directions, and the width of the front surface is greater than the width of the rear surface, and
on the front surface, a plurality of grooves having a linear structure with respect to the widthwise direction so that absorption of cold energy from an outside or emission of cold energy inside the case can be quickly performed, are formed to be spaced apart from one another in a lengthwise direction of the case, and
on the rear surface, a plurality of grooves having a linear structure with respect to the widthwise direction so that absorption of cold energy from an outside or emission of cold energy inside the case can be quickly performed, is are formed to be spaced apart from one another in a lengthwise direction of the case, and when multiple cases are stacked in the forward and backward directions and change into a sold phase, a width of the front surface of the case disposed in a lower portion of a stack of the packs is more smaller than a width of the rear surface of the case disposed in an upper portion of the stack of the packs so that the case disposed in the lower portion is exposed by a difference between the width of the front surface of the case disposed in the lower portion and the width of the rear surface of the case disposed in the upper portion.

2. The bottle type cooling pack of claim 1, wherein, when the multiple cases are stacked in the forward and backward directions, protrusions are formed on one of one portion between the plurality of grooves of the front surface and one portion between the plurality of grooves of the rear surface, and insertion grooves into which the protrusions are respectively inserted, are formed in another one of one portion between the plurality of grooves of the front surface and one portion between the plurality of grooves of the rear surface.

3. The bottle type cooling pack of claim 1, wherein the case further comprises:
an injection portion, which is formed to communicate with the storage space so that the refrigerant is injected or discharged through the injection portion; and
an injection portion stopper for opening/closing the injection portion.

4. The bottle type cooling pack of claim 2, wherein, when the lower case and the upper case are stacked on each other, protrusions of the lower case are press-fitted to the insertion grooves stormed in the upper case.

5. The bottle type cooling pack of claim 2, wherein the protrusions are formed in four areas spaced apart from one another by a set distance in lengthwise and widthwise directions based on a center of the front surface of the case.

6. The bottle type cooling pack of claim 5, wherein the protrusions comprise two protrusions spaced apart from each other in the widthwise direction in each of the four areas.

7. The bottle type cooling pack of claim 2, wherein the insertion grooves are formed in four areas spaced apart from one another by a set distance in the lengthwise and widthwise directions based on the center of the rear surface of the upper case so that, when the upper case is stacked on an upper portion of the lower case, the protrusions of the lower case can be inserted into the insertion grooves.

8. The bottle type cooling pack of claim 2, wherein the insertion grooves comprise two insertion grooves spaced apart from each other in each of the four areas in the widthwise direction.

9. The bottle type cooling pack of claim 2, wherein the front surface further comprises a rib structure, which is formed in the widthwise direction and is installed to reduce a change in a volume of the case even when the volume changes while the phase of the refrigerant changes, and
the rear surface further comprises a rib structure, which is formed in the widthwise direction and is installed to reduce a change in a volume of the case even when the volume changes while the phase of the refrigerant changes, and
the rib structure formed on the front surface of the case disposed in the lower portion and the rib structure formed on the rear surface of the case disposed in the upper portion are installed to face each other when the case disposed in the upper portion is stacked on the case disposed in the lower portion.

10. The bottle type cooling pack of claim 9, wherein the rib structure comprises:
a first rib structure; and
a second rib structure disposed to be spaced apart from the first rib structure in the lengthwise direction.

11. The bottle type cooling pack of claim 9, wherein, in the case, protrusions are formed on the rib structure formed on the front surface, and insertion portions are formed on the rib structure formed on the rear surface.
